(19) United States
(12) Patent Application Publication
(10) Pub. No.: US 2004/0150600 A1
(43) Pub. Date: Aug. 5, 2004

(54) Liquid-crystal apparatus, driving method therefor, and electronic unit

(75) Inventors: Daisuke Kojima, Chino-shi (JP); Takashi Sato, Chino-shi (JP); Akihiko Ito, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/753,376

(22) Filed: Jan. 9, 2004

(30) Foreign Application Priority Data
Jan. 31, 2003 (JP) 2003-024081

(51) Int. Cl. G09G 3/36

(52) U.S. Cl. 345/96

(57) ABSTRACT

To avoid the adverse effects of a horizontal electric field and vertical crosstalk a liquid-crystal apparatus is characterized by including a Y driver to sequentially send gate signals to gate lines in a liquid-crystal display section; data-signal generation device to divide a field into a plurality of sub fields in the time axis, to use a sub field as a control unit, and to generate a data signal which specifies a sub field to which an on-voltage is applied and a sub field to which an off-voltage is applied, according to data to be displayed; and X driver device to generate the on-voltage or the off-voltage according to the data signal, to invert the level of the generated on-voltage or off-voltage in polarity in a selection period in which pixels arranged on one line in the gate-line direction are driven in the liquid-crystal display section, to invert the polarity of the generated on-voltage or off-voltage in a period in which pixels arranged on all lines in the liquid-crystal display section are driven, and to send the generated on-voltage or off-voltage to source lines as source voltages.

### BACKGROUND OF THE INVENTION

1. Field of Invention

The present invention relates to pulse-width-modulation liquid-crystal display apparatuses having reduced vertical crosstalk, driving methods therefor, and

2. Description of Related Art

Electro-optic apparatuses are used as display devices which substitute for cathode-ray tubes (CRTs). For example, liquid-crystal display apparatuses using liquid crystal as an electro-optic material are used widely for display sections in various information processing units, for liquid-crystal TV sets, and for others.

Such a liquid-crystal display apparatus is, for example, formed of an element substrate provided with pixel electrodes arranged in a matrix manner and switching elements, such as TFTs (thin-film transistors), connected to the pixel electrodes; an opposing substrate on which an opposing electrode which opposes the pixel electrodes is formed; and liquid crystal, which is an electro-optic material, filled up between the substrates.

The liquid-crystal display apparatus having the above structure has two display modes: a normally white mode in which a white screen is displayed when a voltage is not applied, and a normally black mode in which a black screen is displayed when a voltage is not applied.

An operation to display an image with gradations in the liquid-crystal display apparatus will be described next.

The switching elements are turned on by scanning signals (gate signals) sent through scanning lines (gate lines). When the scanning signals are applied to the switching elements to turn them on, image signals having the voltages corresponding to gradations are applied to pixel electrodes through data lines (source lines). Then, the electric charges corresponding to the voltages of the image signals are accumulated between the pixel electrodes and the opposing electrode. After the electric charges are accumulated, even if the scanning signals are removed to turn off the switching elements, the accumulation states of the electric charges at the electrodes are maintained by the capacitive characteristic of the liquid-crystal layer and a storage capacitor.

When the switching elements are driven and the amounts of accumulated electric charges are controlled according to gradations in this way, the alignment state of the liquid crystal is changed at the pixels, the optical transmittance ratio is changed, and brightness is changed at the pixels. Thus, gradation display becomes possible.

With the capacitive characteristics of the liquid-crystal layer and the storage capacitor being taken into account, charges need to be applied to the liquid-crystal layer at the pixels just for a partial period. Therefore, to drive a plurality of pixels arranged in a matrix manner, it is necessary that a scanning signal be simultaneously applied to pixels connected to the same scanning line through the scanning line, image signals be sent to the pixels through the data lines, and the scanning line connected to the pixels to which the image signals are sent be sequentially switched. In other words, in the liquid-crystal display apparatus, time-division multiplex driving is allowed, in which the scanning lines and the data lines are shared by a plurality of pixels.

The application of the DC component of an applied signal may cause the decomposition of the liquid crystal, contamination due to impurities in liquid-crystal cells, displayed-image sticking, and others in the liquid-crystal display apparatus. Therefore, in general, inversion driving is achieved in which the polarities of driving voltages for each pixel electrode are inverted, for example, at each frame of an image signal. In plane inversion driving, such as frame inversion driving, the polarities of driving voltages for all pixel electrodes constituting an image display area are made identical and the driving voltages are inverted at a constant interval.

As described above, in the liquid-crystal display apparatus, the driving voltages are applied to the pixels just for a partial period with the capacitive characteristic being taken into account. Even when the driving voltages are not applied, however, voltages applied to the pixels are changed due to the effect of coupling capacitors and the leakage of electric charges. Such a potential fluctuation causes image-quality deterioration especially at an intermediate-gradation area.

FIG. 17 is a view used for describing such a problem. FIG. 18 and FIG. 19 are waveform charts used for describing the liquid-crystal driving potentials corresponding to FIG. 17. In FIG. 18 and FIG. 19, Vs indicates the voltage applied to a source line, VA (solid line) indicates the voltage applied to the pixel electrode at point A, and VB (one-dot chain line) indicates the voltage applied to the pixel electrode at point B. FIG. 18 shows a vertical-crosstalk phenomenon caused by capacitive coupling, and FIG. 19 shows a vertical-crosstalk phenomenon caused by current leakage.

It is assumed here that an image signal is sent to the liquid-crystal panel to display a rectangular black part at the center of the screen and an intermediate-gradation gray part at the other area in the screen. FIG. 17 shows the entire screen of the liquid crystal panel in this case. As shown in FIG. 17, in this case, an image part darker than the intended gray is displayed above the black part, and an image part brighter than the intended gray is displayed below the black part.

In FIG. 18 and FIG. 19, Vs indicates a source potential waveform applied to the source line corresponding to the position of the vertical line passing through the points A and B in FIG. 17. In FIG. 18 and FIG. 19, positive-polarity driving is achieved for the liquid crystal in the N-th frame, and negative-polarity driving is achieved for the liquid crystal in the (N+1)-th frame. At the periods T1 and. T2 corresponding to the black part shown in FIG. 17, large differences are made between the source potential and the potential (opposing potential) of the opposing electrode. At the periods corresponding to the gray part, including point C, small differences are made between the source potential and the opposing potential.

In FIG. 18, VA and VB having dotted lines at the periods T1 and T2 indicate ideal potential waveforms applied to the pixel electrodes which do not cause vertical crosstalk. At the timing t1 corresponding to the vertical screen position of point A in the N-th frame, the TFT of the pixel at point A is turned on to apply an image signal (driving potential) having the level corresponding to the intermediate-gradation gray to the pixel electrode at point A. At a timing when an image signal is applied to a pixel in the next line of point A, the TFT of the pixel at point A is off, and the driving potential of the pixel electrode at point A is maintained by the liquid-crystal capacitor and a storage capacitor. At a timing corresponding to the vertical screen position of point A in the (N+1)-th frame, a negative-polarity driving potential is applied to the pixel at point A. This driving potential is also maintained until the next, (N+2)-th frame. The same applies to point B. A driving potential applied to the pixel electrode of the pixel at point B is maintained until the next frame by the liquid-crystal capacitor and the storage capacitor.

While the TFTs are off, however, the pixel electrodes are affected by the source-line potential due to the coupling capacitor and electric-charge leakage. As indicated by VA and VB in FIG. 18 and FIG. 19, the driving potentials of the pixels at points A and B become higher than the level determined by the image signals in the period T1, and the driving potentials of the pixels at points A and B become lower than the level determined by the image signals in the period T2. The driving potential of the pixel at point A is shown by VA, and the driving potential of the pixel at point B is shown by VB. At the periods T1 and T2, the difference between the driving potential and the opposing potential becomes larger at point A to make its brightness darker than the intended gray level, and the difference between the driving potential and the opposing potential becomes smaller at point B to make its brightness brighter than the intended gray level.

In the above description, the image signals applied to the data lines are the voltages corresponding to gradations, that is, analog signals. Therefore, a D/A conversion circuit and an operational amplifier are required as peripheral circuits of the liquid-crystal apparatus, causing the cost of the entire apparatus higher.

In addition, the characteristics of the D/A conversion circuit and the operational amplifier, and the non-uniformity of various wiring resistors may cause display unevenness. Therefore, high-quality display is very difficult to achieve, and this problem becomes heavy especially in high-resolution display.

There has been proposed a sub-field driving method in which pixels are driven in a digital manner, for liquid-crystal apparatuses. In the sub-field driving method, one field is divided into a plurality of sub fields in the time axis, and an on-voltage or an off-voltage is applied to each pixel according to its gradations in each sub field.

In the sub-field driving method, the level of the voltage applied to the liquid crystal is not changed, but a period in which voltage pulses are applied to the liquid crystal is changed to substantially change the voltage (effective voltage) applied to the liquid crystal to control the transmittance ratio of the liquid-crystal panel. Therefore, only two voltage levels are required to drive the liquid crystal. They are an on-level and an off-level. The sub-field driving method is disclosed in Japanese Unexamined Patent Application Publication No. 2002-108302.

Even in the sub-field driving method, the effect of the coupling capacitor and electric-charge leakage may cause the fluctuations of the voltages applied to the pixels and vertical crosstalk occurs.

To avoid image-quality deterioration caused by vertical crosstalk, inversion driving has been employed in liquid-crystal apparatuses. In the inversion driving, one-frame inversion driving and line inversion driving in which the polarities of driving potentials are changed at each line are combined.

An apparatus which achieves such line inversion driving is disclosed in Japanese Unexamined Patent Application Publication No. 05-61440.

### SUMMARY OF THE INVENTION

In the line inversion driving, however, an electric field (hereinafter called a horizontal electric field) is generated between adjacent pixel electrodes on the same substrate in the column or row direction in which voltages having different polarities are applied. This horizontal electric field affects the rotational movement of liquid-crystal molecules in the tilt direction. In other words, when line inversion is performed, a potential difference is generated between adjacent pixels to form an electric field between them. This electric field may cause image-quality deterioration in the liquid-crystal apparatus which controls the alignment state of the liquid crystal by an electric field generated between the pixel electrodes and the opposing electrode.

The present invention has been made in consideration of the foregoing problems. The present invention provides a liquid-crystal apparatus which employs polarity inversion driving at an interval of a half of a selection period to avoid the effects of a coupling capacitor, electric-charge leakage, and a horizontal electric field to enhance image quality, a driving method therefor, and an electronic unit.

A liquid-crystal apparatus according to an aspect of the present invention is characterized by including a liquid-crystal display section in which pixels are formed correspondingly to the intersections of a plurality of source lines and a plurality of gate lines arranged in a grid manner, and switching elements provided for the pixels are turned on by gate signals sent to the gate lines to allow source voltages sent to the source lines to be given to the pixel electrodes of the pixels through the switching elements to drive liquid crystal; a Y driver to sequentially send the gate signals to the gate lines in the liquid-crystal display section; data-signal generation device to divide a field into a plurality of sub fields in the time axis, for using a sub field as a control unit, and to generate a data signal which is used for sub-field driving where a gradation expression is achieved according to the state and the time ratio of a light transmission state and a light non-transmission state of the liquid crystal in a unit time by sending an on-voltage which can saturate the transmittance of the liquid crystal or an off-voltage which can make the liquid crystal have the light non-transmission state, and which specifies a sub field to which the on-voltage is applied or a sub field to which the off-voltage is applied, according to data to be displayed; and X driver device to generate the on-voltage or the off-voltage according to the data signal, to invert the generated on-voltage or off-voltage in polarity in a selection period in which pixels arranged on one line in the gate-line direction are driven in the liquid-crystal display section, and to send the generated on-voltage or off-voltage to the source lines as the source voltages.

With such a structure, in the liquid-crystal display section, the pixels are formed correspondingly to the intersections of the plurality of source lines and the plurality of gate lines arranged in a grid manner, the switching elements provided for the pixels are turned on by the gate signals sent from the Y driver to the gate lines, and with this, the source voltages sent to the source lines are given to the pixel electrodes of the pixels through the switching elements to drive the liquid crystal. The on-voltage which can saturate the transmittance of the liquid crystal or the off-voltage which can make the liquid crystal have the light non-transmission state is used as the source voltages, and a gradation expression is achieved according to the state and the time ratio of a light transmission state and a light non-transmission state of the liquid crystal in a unit time. The data-signal generation device generates the data signal which specifies a sub field to which the on-voltage is applied and a sub field to which the off-voltage is applied, according to data to be displayed. The X driver device generates the on-voltage or the off-voltage according to the data signal. In addition, the X driver device inverts the generated on-voltage or off-voltage in polarity in a selection period in which pixels arranged on one line in the gate-line direction are driven in the liquid-crystal display section. Finally, the levels of source voltages applied in the second half of the selection period in which pixels arranged on one line in the gate-line direction are driven in the liquid-crystal display section are written into the liquid crystal. When frame inversion is also used, since writing to the liquid crystal of all the pixels in the liquid-crystal display section is achieved with the same polarity, a horizontal electric field is not generated. Since the source voltages are inverted in polarity in the selection period in which pixels arranged on one line in the gate-line direction are driven in the liquid-crystal display section, even if the pixel electrodes are affected by the source voltages, the effects of the source voltages are averaged in the selection period in which pixels arranged on one line in the gate-line direction are driven in the liquid-crystal display section. The fluctuations of the effective voltages in a period where the switching elements are off are small. With this, vertical crosstalk caused by the effects of the source voltages is reduced.

The Y driver may generate gate signals used to send the source voltages to the pixel electrodes at least in one of the periods before and after the switching timing when the on-voltage or the off-voltage inverted in polarity by the X driver device is changed from one polarity to the other polarity or from the other polarity to the one polarity.

With such a structure, the levels of source voltages applied in the second half or the first half of the selection period in which pixels arranged on one line in the gate-line direction are driven in the liquid-crystal display section are written into the liquid crystal. When frame inversion is also used, since writing to the liquid crystal of all the pixels in the liquid-crystal display section is achieved with the same polarity, a horizontal electric field is not generated.

The X driver device may set the switching timing when the on-voltage or the off-voltage is changed from one polarity to the other polarity or from the other polarity to the one polarity, at an interval of a half of the selection period in which pixels arranged on one line in the gate-line direction are driven in the liquid-crystal display section.

With such a structure, a driving period using a high level is equal to a driving period using a low level, and the effects of the source voltages can be effectively suppressed.

The X driver device may set the switching timing when the on-voltage or the off-voltage is changed from one polarity to the other polarity or from the other polarity to the one polarity, at an interval other than that of a half of the selection period in which pixels arranged on one line in the gate-line direction are driven in the liquid-crystal display section.

With such a structure, a driving period using a high level and a driving period using a low level can be set appropriately according to the driving capacity of the X driver device.

The liquid-crystal apparatus may be configured such that the Y driver generates gate signals used to send the source voltages to the pixel electrodes at least in one of the periods before and after the switching timing when the on-voltage or the off-voltage inverted in polarity by the X driver device is changed from one polarity to the other polarity or from the other polarity to the one polarity, and the X driver device changes the polarity of the on-voltage or the off-voltage according to the ratio of the selection period in which pixels arranged on one line in the gate-line direction are driven in the liquid-crystal display section and a period in which the gate signals used to send the source voltages to the pixel electrodes are being generated.

With such a structure, even if a driving period using a high level differs from a driving period using a low level, since the on-voltage or off-voltage having the polarity corresponding to the ratio of the driving period using the high level and the driving period using the low level is sent to the pixel electrodes, the effects of the source voltages can be effectively suppressed.

The X driver device may invert the polarity of the generated on-voltage or off-voltage at each period in which pixels arranged in all lines in the liquid-crystal display section are driven, and send the on-voltage or off-voltage to the source lines as the source voltages.

With such a structure, since the source voltages sent to the source lines are inverted in polarity in the selection period in which pixels arranged on one line in the gate-line direction are driven in the liquid-crystal display section, even if the pixel electrodes are affected by the source voltages, the effects of the source voltages are averaged in the selection period in which pixels arranged on one line in the gate-line direction are driven in the liquid-crystal display section. The fluctuations of the effective voltages in a period where the switching elements are off are small. With this, vertical crosstalk caused by the effects of the source voltages is reduced.

A driving method for a liquid-crystal apparatus which includes a liquid-crystal display section in which pixels are formed correspondingly to the intersections of a plurality of source lines and a plurality of gate lines arranged in a grid manner, and switching elements provided for the pixels are turned on by gate signals sent to the gate lines to allow source voltages sent to the source lines to be given to the pixel electrodes of the pixels through the switching elements to drive liquid crystal, the driving method according to an aspect of the present invention is characterized by including a process of sequentially sending the gate signals to the gate lines in the liquid-crystal display section, a process of dividing a field into a plurality of sub fields in the time axis, of using a sub field as a control unit, and of generating a data signal which is used for sub-field driving where a gradation expression is achieved according to the state and the time ratio of a light transmission state and a light non-transmission state of the liquid crystal in a unit time by sending an on-voltage which can saturate the transmittance of the liquid crystal or an off-voltage which can make the liquid crystal have the light non-transmission state, and which specifies a sub field to which the on-voltage is applied and a sub field to which the off-voltage is applied, according to data to be displayed, and a process of generating the on-voltage or the off-voltage according to the data signal, of inverting the generated on-voltage or off-voltage in polarity in a selection period in which pixels arranged on one line in the gate-line direction are driven in the liquid-crystal display section, and of sending the generated on-voltage or off-voltage to the source lines as the source voltages.

With such a structure, the switching elements provided for the pixels are turned on by the gate signals sent to the gate lines, and with this, the source voltages sent to the source lines are given to the pixel electrodes of the pixels through the switching elements to drive the liquid crystal. The on-voltage which can saturate the transmittance of the liquid crystal or the off-voltage which can make the liquid crystal have the light non-transmission state is used as the source voltages, and a gradation expression is achieved according to the state and the time ratio of a light transmission state and a light non-transmission state of the liquid crystal in a unit time. The data signal which specifies a sub field to which the on-voltage is applied and a sub field to which the off-voltage is applied is generated according to data to be displayed. The on-voltage or the off-voltage is generated according to the data signal. The generated on-voltage or off-voltage is inverted in polarity in a selection period in which pixels arranged on one line in the gate-line direction are driven in the liquid-crystal display section. When frame inversion is also used, since writing to the liquid crystal of all the pixels in the liquid-crystal display section is achieved with the same polarity, a horizontal electric field is not generated. Since the source voltages are inverted in polarity in the selection period in which pixels arranged on one line in the gate-line direction are driven in the liquid-crystal display section, even if the pixel electrodes are affected by the source voltages, the effects of the source voltages are averaged in the selection period in which pixels arranged on one line in the gate-line direction are driven in the liquid-crystal display section. The fluctuations of the effective voltages in a period where the switching elements are off are small. With this, vertical crosstalk caused by the effects of the source voltages is reduced.

The process of sending the source voltages to the source lines may include a process of inverting the polarity of the generated on-voltage or off-voltage at each period in which pixels arranged in all lines in the liquid-crystal display section are driven.

With such a structure, the on-voltage or off-voltage is inverted in polarity in the selection period in which pixels arranged on one line in the gate-line direction are driven in the liquid-crystal display section, is also inverted at each period in which pixels on all lines in the liquid-crystal display section are driven, and is sent to the source lines. With this, writing to the liquid crystal of all the pixels in the liquid-crystal display section is achieved with the same polarity in the same frame period, and a horizontal electric field is not generated. Since the source voltages are inverted in polarity in the selection period in which pixels arranged on one line in the gate-line direction are driven in the liquid-crystal display section, even if the pixel electrodes are affected by the source voltages, the effects of the source voltages are averaged in the selection period in which pixels arranged on one line in the gate-line direction are driven in the liquid-crystal display section. The fluctuations of the effective voltages in a period where the switching elements are off are small. With this, vertical crosstalk caused by the effects of the source voltages is reduced.

An electronic unit according to an aspect of the present invention is characterized by including the above-described liquid-crystal apparatus.

With such a structure, high-quality images are obtained with the adverse effects of a horizontal electric field and vertical crosstalk being avoided.

### BRIEF DESCRIPTION OF THE DRAWINGS

FIG. 1 is a block schematic showing a liquid-crystal apparatus according to an exemplary embodiment of the present invention;

FIG. 2 is a view showing a specific structure of a pixel shown in FIG. 1;

FIG. 3 is a block schematic showing a specific structure of a driving circuit 301 shown in FIG. 1;

FIG. 4 is a block schematic showing a specific structure of an X driver 500 shown in FIG. 1;

FIG. 5 is a view used for describing the operation of a voltage raising circuit 540;

FIG. 6 is a waveform view used for describing polarity inversion driving performed at each half of a selection period and polarity inversion driving performed at each frame, with the horizontal axis indicating the time and the vertical axis indicating the potential of a data signal;

FIGS. 7(A)-7(D) are a timing chart used for describing an operation in an exemplary embodiment;

FIG. 8 is a view used for describing a reduction in vertical crosstalk according to an exemplary embodiment;

FIGS. 9(A)-9(D) are a waveform chart used for describing a reduction in vertical crosstalk according to an exemplary embodiment;

FIGS. 10(A)-10(C) are a waveform view showing a modification of the present exemplary embodiment;

FIGS. 11(A)-11(B) are a waveform view showing a modification of an exemplary embodiment;

FIG. 12 is a plan showing the structure of the liquid-crystal apparatus according to an exemplary embodiment;

FIG. 13 is a cross-sectional view showing the structure of the liquid-crystal apparatus according to an exemplary embodiment;

FIG. 14 is a plan showing a projector which uses the liquid-crystal apparatus according to an exemplary embodiment as a light valve;

FIG. 15 is a perspective view showing the structure of a personal computer serving as an electronic unit according to an exemplary embodiment;

FIG. 16 is a perspective view showing the structure of a portable telephone serving as an electronic unit according to an exemplary embodiment;

FIG. 17 is a view used for describing a problem in a related art case;

FIG. 18 is a waveform view of liquid-crystal driving voltages corresponding to the case shown in FIG. 17; and

FIG. 19 is a waveform view of liquid-crystal driving voltages corresponding to the case shown in FIG. 17.

### DETAILED DESCRIPTION OF EXEMPLARY EMBODIMENTS

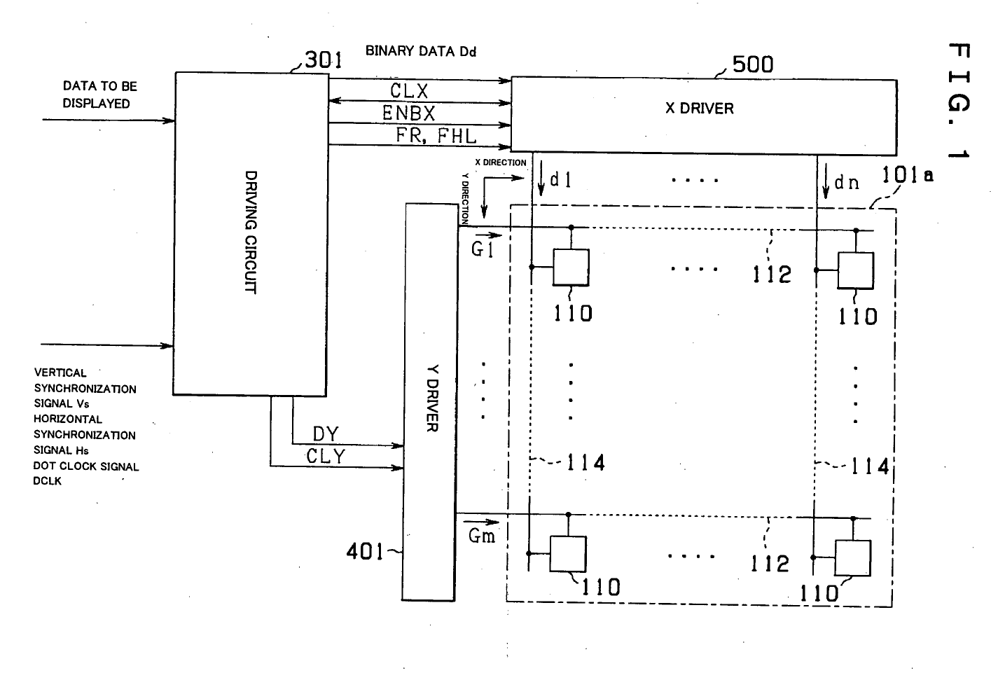

Exemplary embodiments of the present invention will be described below in detail by referring to the figures. FIG. 1 is a block schematic showing a liquid-crystal apparatus according to an exemplary embodiment of the present invention.

In the present exemplary embodiment, sub-field driving is employed as the driving method of liquid crystal. One field is divided into a plurality of sub-fields in the time axis, a sub-field is used as a control unit, and each pixel is driven once a sub-field. In other words, in sub-field driving, a driving voltage is written into each pixel the same number of times as the number of sub fields, in one field. In the present exemplary embodiment, to avoid the effects of a coupling capacitor, electric-charge leakage, and a horizontal electric field, liquid-crystal driving voltages are inverted in polarity at an interval of (½)H (selection period, described later), and also inverted in polarity at each frame.

Sub-field driving (pulse-width modulation method) will be described first.

In analog driving, liquid crystal is driven by a voltage equal to or lower than the driving voltage (hereinafter called a liquid-crystal saturation voltage) which saturates the transmittance of the liquid crystal. Therefore, the liquid-crystal transmittance is almost proportional to the effective value of the driving voltage, and a screen having a brightness proportional to the driving voltage is obtained.

In contrast, in sub-field driving, a driving voltage (hereinafter called an on-voltage) equal to or higher than the liquid-crystal saturation voltage is applied, or the same voltage as that of the opposing electrode (hereinafter called an off-voltage) is applied. Since the transmittance of the liquid crystal is almost proportional to the integrated value (effective value) of the driving voltage, the ratio of the period when the driving voltage (on-voltage) is applied to the pixel electrodes to the period when the off-voltage is applied determines the transmittance of the liquid crystal in sub-field driving. At each sub field, the on-voltage or the off-voltage needs to be sent to all pixels in the screen. The on-voltage and the off-voltage are sent to each pixel as pulse signals having the pulse width determined according to the sub-field period and the number of lines in a display area.

When the on-voltage applied to the liquid crystal is maintained by the capacitor of the liquid crystal and the storage capacitor until the off-voltage is applied, if sub fields have the same period in the time axis, the ratio of the number of sub fields in which the on-voltage is applied to a pixel to the number of sub fields in which the off-voltage is applied determines the transmittance of the pixel.

The lengths of sub fields in the time axis may be weighted. When one field is divided into four sub fields, first to fourth sub fields, in the time axis, for example, if the ratio of the lengths of the first to fourth sub fields is 1:2:4:8, pulse signals to supply the on-voltage or the off-voltage in the first to fourth sub fields correspond to second, third, fifth, and ninth gradations in 16 gradations from 0 to 15. When the transmittance 0% to 100% is expressed by 16 gradations, if a fourth gradation is to be obtained, it is necessary that pulse signals to supply the on-voltage be sent to the pixel electrodes in the first and second sub fields, and pulse signals to supply the off-voltage be sent to the pixel electrodes in the third and fourth sub fields.

In FIG. 1, the liquid-crystal apparatus according to the present exemplary embodiment is formed of a display area 101a where liquid crystal, which is an electro-optic material, is used, a Y driver 401 and an X driver 500 to drive pixels in the display area 101a, and a driving circuit 301 to send various signals to the Y driver 401 and to the X driver 500.

The liquid-crystal apparatus uses a transparent substrate, such as a glass substrate, as an element substrate. On the element substrate, transistors to drive pixels, and peripheral driving circuits are formed. In the display area 101a on the element substrate, a plurality of gate lines (scanning lines) 112 are formed so as to extend in the X (row) direction shown in FIG. 1, and a plurality of source lines (data lines) 114 are formed so as to extend in the Y (column) direction. Pixels 110 are formed in a matrix manner corresponding to the intersections of the gate lines 112 and the source lines 114.

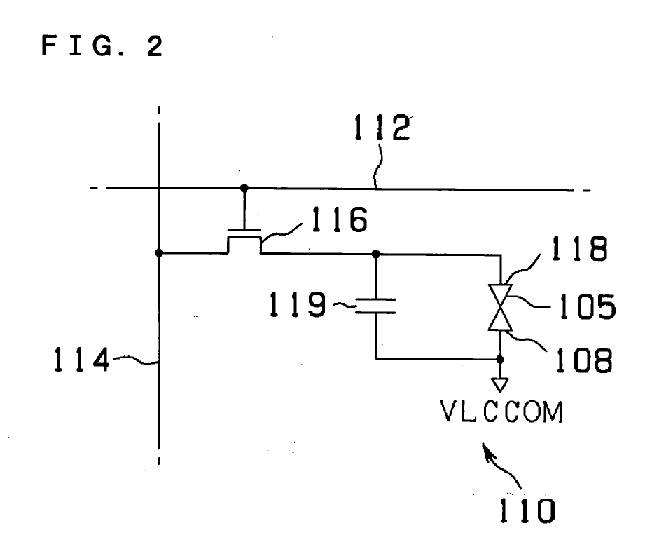

FIG. 2 is a view showing a specific structure of a pixel shown in FIG. 1.

Each pixel 110 is provided with a TFT 116, serving as switching device. The gate of the TFT 116 is connected to the gate line 112, the source thereof is connected to the source line 114, and the drain thereof is connected to the pixel electrode 118. Liquid crystal 105, which is an electro-optic material, is sandwiched by the pixel electrode 118 and the opposing electrode 108 to form a liquid-crystal layer.

The opposing electrode 108 is actually a transparent electrode formed on the entire plane of the opposing substrate so as to be opposite to the pixel electrodes 118, as described later.

An opposing-electrode voltage VLCCOM is applied to the opposing electrode 108. A storage capacitor 119 is formed between the pixel electrode 118 and the opposing electrode 108 to accumulate electric charges together with the electrodes which sandwich the liquid-crystal layer. In the case shown in FIG. 2, the storage capacitor 119 is formed between the pixel electrode 118 and the opposing electrode 108. The storage capacitor 119 may be formed between the pixel electrode 118 and the ground potential GND, or between the pixel electrode 118 and the gate line. Alternatively, wiring having the same potential as the opposing-electrode voltage VLCCOM is formed at the element substrate to form the storage capacitor between the pixel electrode and the wire.

The Y driver 401, described later, sends gate signals G1 G2, . . . , and Gm to the gate lines 12, respectively. A gate signal turns on all the TFTs 116 of the pixels arranged along the corresponding gate line, and a source voltage (on-voltage or off-voltage) sent from the X driver 500, described later, to each source line 114 is written into the pixel electrode 118. A potential difference is generated between the pixel electrode 118 to which the source voltage has been written, and the opposing electrode 108 to change the alignment state of the set of molecules in the liquid crystal 105 to modulate light. Hence, gradation display is achieved.

As described above, in the present exemplary embodiment, one field is divided into a plurality of sub fields in the time axis, and the writing of each pixel 110 is controlled in each sub field.

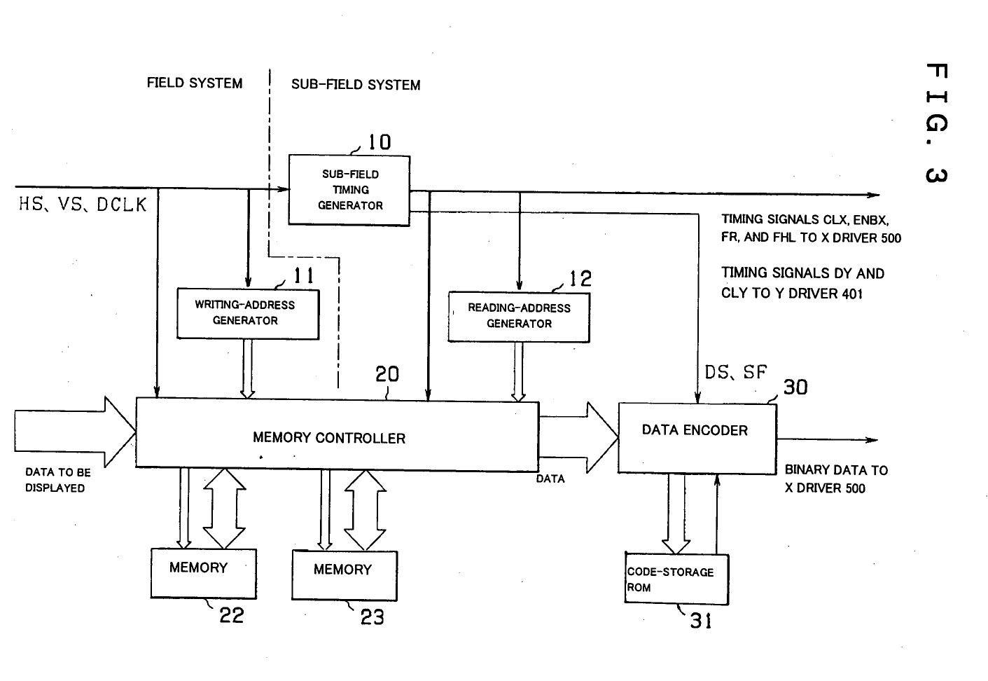

A driving system to drive the display area will be described next. FIG. 3 is a block schematic showing a specific structure of the driving circuit 301 shown in FIG. 1.

In FIG. 3, a sub-field timing generator 10 receives a vertical synchronization signal Vs, a horizontal synchronization signal Hs, and a dot clock signal DCLK from the outside. The sub-field timing generator 10 generates timing signals used in a sub-field system according to the vertical synchronization signal Vs, the horizontal synchronization signal Hs, and the dot clock signal DCLK.

More specifically, the sub-field timing generator 10 generates a transfer clock signal CLK, a data enable signal ENBX, and polarity inversion signals FR and FHL all of which are for display driving, and outputs them to the X driver 500. The sub-field timing generator 10 also generates a scanning start pulse signal DY and a transfer clock signal CLY, and outputs them to the Y driver 401. The sub-field timing generator 10 further generates a data transfer start pulse signal DS and a sub-field identification signal SF, both of which are used inside a controller, and outputs them to a data encoder 30.

The polarity inversion signal FR is a signal which is inverted in polarity at each field. The polarity inversion signal FHL is a signal which is inverted in polarity at each (½)H (selection period). The scanning start pulse signal DY is a pulse signal output at the start of each sub field. When the scanning start pulse signal DY is input to the Y driver 401, the Y driver 401 outputs gate pulses (G1 to Gm).

As described above, one field is divided into a plurality of sub fields in the time axis, and a binary voltage signal is applied to the liquid-crystal layer according to gradation data at each sub field. The start pulse signal DY indicates the switching of each sub field.

The transfer clock signal CLY specifies a scanning rate at the scanning side (Y side). Gate pulses (G1 to Gm) are sent to the scanning lines in synchronization with the transfer clock signal CLY. The data enable signal ENBX determines the timing when the same number of data items as that of horizontal pixels, stored in an X-bit shift register 510, described later, in the X driver 500 are output in parallel. The transfer clock signal CLX is a clock signal to transfer data to the X driver 500. The data transfer start pulse signal DS specifies the timing when data transfer from the data encoder 30 to the X driver 500 is started, and is sent from the sub-field timing generator 10 to the data encoder 30. The sub-field identification signal SF indicates to the data encoder 30 which sub field the pulse falls in.

A driving-voltage generation circuit, not shown, generates a voltage V2 used to generate a gate signal and sends it to the Y driver 401, generates voltages V1, −V1, and V0 used to generate a source-line driving signal and sends them to the X driver, and generates the opposing-electrode voltage VLCCOM and applies it to the opposing electrode 108.

The voltage V1 is the on-voltage output to the liquid-crystal layer as a positive-polarity high-level signal relative to the voltage V0 when the AC driving signals FR and FHL have a high level (hereinafter called “H”). The voltage −V1 is the off-voltage output to the liquid-crystal layer as a negative-polarity high-level signal relative to the voltage V0 when the AC driving signals FR and FHL have a low level (hereinafter called “L”).

Input data to be displayed is sent to a memory controller 20. A writing-address generator 11 identifies the position of data being sent, on the screen according to the horizontal synchronization signal Hs, the vertical synchronization signal Vs, and the dot clock signal DCLK input from the outside, generates a memory address to store the data to be displayed in a memory 22 or 23, according to the result of identification, and outputs them to the memory controller 20.

A reading-address generator 12 determines a display position on the screen according to a timing signal for a sub-field system, generated by the sub-field timing generator 10, generates a memory address to read data from the memory 22 or 23 in accordance with the result of determination, according to the same rule as in writing, and outputs the addresses to the memory controller 20.

The memory controller 20 performs control to write input data to be displayed, in the memory 22 or 23, and to read data from the memory 22 or 23.

More specifically, the memory controller 20 writes data input from the outside into the memory 22 or 23 in synchronization with the timing signal DCLK at the address generated by the writing-address generator 11. The memory controller 20 reads data from the memory 22, or 23 in synchronization with the timing signal CLX generated by the sub-field timing generator 10 at the address generated by the reading-address generator 12. The memory controller 20 outputs read data to the data encoder 30.

In sub-field driving, writing into pixels is achieved in each sub field. Therefore, it is necessary that the data to be displayed be stored in a field memory, and binary data which determines the on or off state of a sub field be generated according to the data to be displayed, read from the field memory at each sub field. The memories 22 and 23 are provided for this reason. One of the memories 22 and 23 is used to write the input data, and the other is used for reading. The roles of the memories 22 and 23 are switched at each field by the memory controller 20.

The memory controller 20 reads data from the memory 22 or 23 in synchronization with the timing signal, and outputs the read data to the data encoder 30 in the next stage in parallel. The data encoder 30 generates an address used to read necessary data from a code-storage ROM 31, according to the data sent from the memory controller 20 and the sub-field identification signal SF sent from the sub-field timing generator 10, reads the data at the address from the code-storage ROM 31, and outputs it to the X driver 500 in synchronization with the data transfer start pulse signal DS.

The code-storage ROM 31 stores, correspondingly to the data (gradation data) of brightness at each pixel, a binary signal Ds (code which specifies the on state or the off state in each sub field in one field) which is “H” or “L” to set the pixel to the on state or the off state in each sub field. The code-storage ROM 31 is structured such that, when data (gradation data) to be written into each pixel and a sub field where writing is performed are input as an address, the ROM 31 outputs one-bit data (binary signal (data) Ds) corresponding to the sub field.

In FIG. 1, the Y driver 401 is a so-called Y shift register. The scanning start pulse signal DY received at the start of a frame is transferred according to the transfer clock signal CLY, and is sequentially and exclusively sent to the gate lines 112 as the gate signals G1, G2, G3, . . . , and Gm.

The X driver 500 sequentially latches the same number (n) of binary data items as that of source lines, and simultaneously sends the latched n binary data items to the corresponding source lines 114 as data signals d1, d2, d3, . . . , and dn corresponding to the pulse signals (on-voltage or off-voltage) described above.

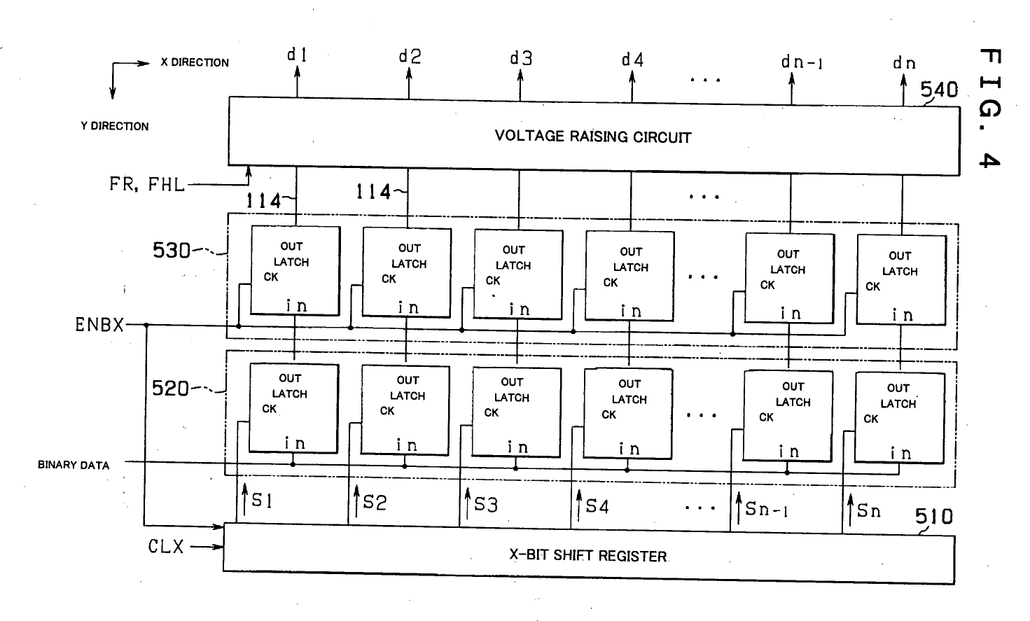

FIG. 4 is a block schematic showing a specific structure of the X driver 500 shown in FIG. 1.

The X driver 500 is formed of an X-bit shift register 510, a first latch circuit 520 for one-line horizontal pixels, a second latch circuit 530, and a voltage raising circuit 540 for one-line horizontal pixels.

The X-bit shift register 510 transfers the data enable signal ENBX received at the start of a horizontal scanning period, according to the clock signal CLX, and sequentially and exclusively sends to the first latch circuit 520 as latch signals S1, S2, S3, . . . , and Sn. The first latch circuit 520 sequentially latches binary data at the falling edges of the latch signals S1, S2, S3, . . . , and Sn. The second latch circuit 530 simultaneously latches the binary data latched by the first latch circuit 520 at the falling edge of the data enable signal ENBX, and sends the data to the source lines 114 as the data signal d1, d2, d3, . . . , and dn through the voltage raising circuit 540.

As described above, in the X driver 500, since the first latch circuit 520 latches the binary signal in a dot sequential manner in a horizontal scanning period, and then, the second latch circuit 530 simultaneously sends the data signals d1, d2, d3, . . . , and dn to the source lines 114 in the next horizontal scanning period, the data encoder 30 outputs the binary signal Ds earlier by one horizontal scanning period than the operations in the Y driver 401 and the X driver 500.

The voltage raising circuit 540 has a polarity inversion function and a voltage raising function. The voltage raising circuit 540 raises a voltage according to the polarity inversion signals FR and FHL. In the present exemplary embodiment, the polarity of the data signal is inverted at each frame by the polarity inversion signal FR which is inverted in polarity every frame, and the polarity of the data signal is inverted at each half of the selection period by the polarity inversion signal FHL which is inverted in polarity at each half of the selection period.

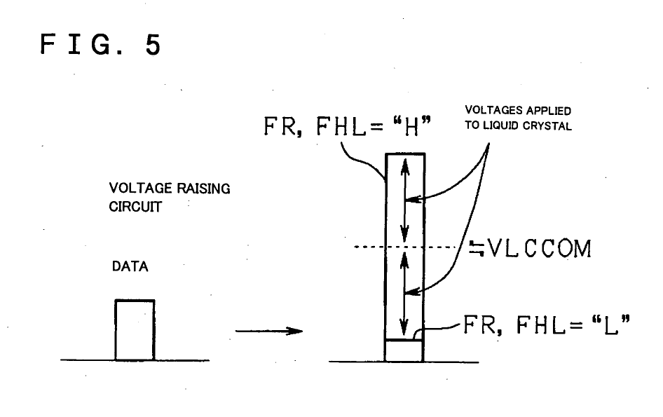

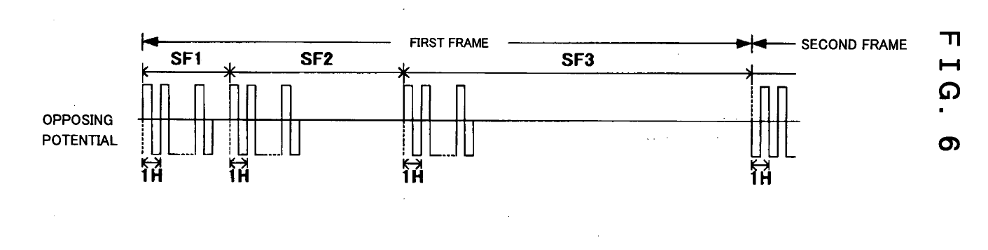

FIG. 5 is a view used to describe the operation of the voltage raising circuit 540. FIG. 6 is a waveform view used to describe polarity inversion driving performed at each half of the selection period and polarity inversion driving performed at each frame, with the horizontal axis indicating the time and the vertical axis indicating the potential of the data signal.

When the polarity inversion signals FR and FHL are “H”, for example, if a data signal which turns on the pixel is input to the voltage raising circuit 540, the voltage raising circuit 540 outputs a positive-polarity driving voltage. When the polarity inversion signals FR and FHL are “L”, if a data signal, which turns on the pixel, is input to the voltage raising circuit 540, the voltage raising circuit 540 outputs a negative-polarity driving voltage. If a data signal which turns off the pixel is input, the voltage raising circuit 540 outputs the VLCCOM potential (off-voltage) irrespective of the states of the polarity inversion signals FR and FHL.

In the present exemplary embodiment, the voltage raising circuit 540 inverts the polarity of the data signal at each frame, and also inverts the polarity of the data signal at each half of the selection period. FIG. 6 shows a data signal sent to a predetermined source line in a predetermined frame when the entire screen is black. In the case shown in FIG. 6, one frame is divided into three sub fields (SF1, SF2, and SF3) in the time axis. The sub field SF2 has twice as long as the period of the sub field SF1, and the sub field SF3 has twice as long as the period of the sub field SF2. Therefore, eight gradations 0 to 7 can be displayed in the case shown in FIG. 6. Each sub field has the same number of selection periods (H) as that of the gate lines in the display area 101a. Each selection period in each sub field has the same length. The n-th selection period in each sub field corresponds to the n-th gate line in the display area 101a.

To display the pixel located at the intersection of a predetermined source line and the fifth gate line at the fourth gradation in eight gradations, for example, it is necessary that a data signal which has the on-voltage at the fifth selection period in each of the sub fields SF1 and SF2 and which has the off-voltage at the fifth selection period in the sub field SF3 be sent to the predetermined source line. In the case shown in FIG. 6, since the on-voltage is applied in all the selection periods, all the pixels connected to the predetermined source line are displayed in black.

In the present exemplary embodiment, as shown in FIG. 6, the data signal is inverted in polarity from the positive polarity to the negative polarity, or from the negative polarity to the positive polarity, in each selection period. In other words, in FIG. 6, the data signal is the positive-polarity “H” in a first half of each selection period and is the negative-polarity “H” in a second half in a first frame, and the data signal is the negative-polarity “H” in a first half of each selection period and is the positive-polarity “H” in a second half in a second frame. The data signal is inverted in polarity at each half of the selection period, and is also inverted in polarity at each frame.

In the first frame in FIG. 6, the data signal has the positive polarity in the first half of the selection period, and has the negative polarity in the second half. The data signal needs to be inverted in level in one selection period. The data signal may, for example, have the negative polarity in the first half and the positive polarity in the second half.

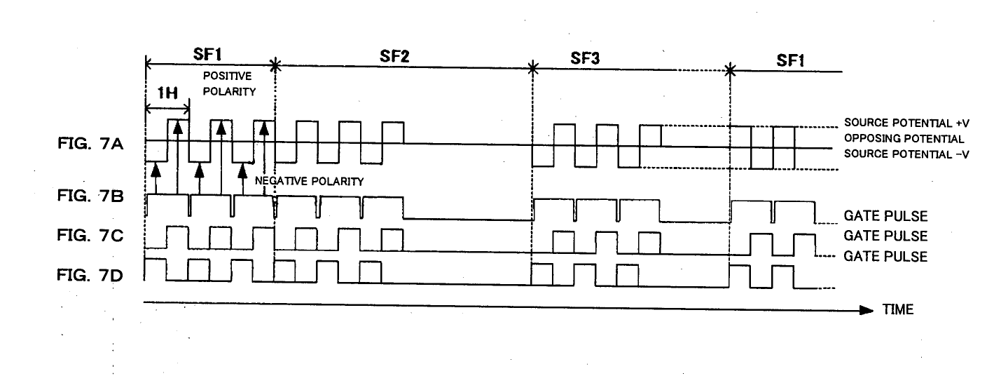

The operation of the liquid-crystal apparatus structured as described above, according to the present exemplary embodiment will be described next by referring to FIG. 7 to FIG. 9. FIG. 7 is a timing chart showing gate signals (gate pulses) output from the Y driver 401 in the three sub fields SF1, SF2, and SF3 in a predetermined field. FIG. 7(A) shows the source voltage, and FIG. 7(B) to FIG. 7(D) show example gate signals. In FIG. 7, to make the figure simple, the number of pulses is set smaller than in the actual case in one sub field period.

It is assumed here that an image signal having a constant level in a predetermined screen, such as data to display a color in the entire screen, is sent to the driving circuit 301. The data to be displayed is converted to binary data by the data encoder in the driving circuit 301, and sent to the X driver 500. The X driver 500 sequentially latches the received binary data corresponding to the source lines, and sends the same number of latched source-line binary data items as the number of horizontal pixels to the voltage raising circuit 540 at the falling edge of the data enable signal ENBX. The voltage raising circuit 540 increases the binary data items in voltage, inverts in polarity at each frame, also inverts in polarity at each half of the selection period according to the polarity inversion signals FR and FHL, and sends them to the source lines 114 as the data signals d1, d2, d3, . . . , and dn.

FIG. 7(A) shows a source voltage (data signal) applied to a predetermined source line in this case. The source voltage is inverted in polarity at each (½)H period with the opposing potential being used as a center potential.

In FIG. 7, the source voltage (data signal) has the negative polarity in the first half of each selection period (H), and has the positive polarity in the second half in a predetermined frame. In the next frame of the predetermined frame, the source voltage (data signal) has the positive polarity in the first half of each selection period (H), and has the negative polarity in the second half. In other words, the source voltage is inverted in polarity at each half of each selection period, and also inverted in polarity at each frame.

The Y driver 401 generates a gate pulse signal having a 1H period according to signals sent from the driving circuit 302. FIG. 7(B) shows an example gate pulse signal. The gate pulse signal shown in FIG. 7(B) has “H” at the first and second halves of each selection period. The gate pulse signal having a 1H (selection) period is sequentially sent to the gate lines 112 at an interval of 1H in the display area 101a. The gate lines in the display area 101a sequentially become “H” at an interval of 1H.

When it is assumed that the TFTs 116 connected to each gate line are turned on by the “H” state of the gate pulse signal, the TFTs 116 connected to each gate line are turned on while the gate pulse signal is “H” to send the data to be displayed, sent through the source lines 114 to the pixel electrodes connected to the drains of the TFTs 116. The TFTs 116 connected to each gate line sends the source voltages to the pixel electrodes only in the 1H period in one frame.

In the present exemplary embodiment, the source voltage is inverted in polarity at each (½)H. In the predetermined frame, the source voltage has the positive polarity at the second half of each selection period, and the liquid crystal is finally driven by the positive-polarity voltage. In the next frame of the predetermined frame, the source voltage has the negative polarity at the second half of each selection period, and the liquid crystal is finally driven by the negative-polarity voltage. In other words, in the case shown in FIG. 7(A) and FIG. 7(B), all pixels are driven by the same-polarity voltage in a frame, and therefore, a horizontal electric field is not generated between vertically adjacent pixels.

In the case shown in FIG. 7(B), a general method to drive the TFTs 116 by the Y driver, corresponding to sub-field driving is employed as it is. In other words, in the case shown in FIG. 7(B), the level of the driving voltage applied to pixels is changed between the first half and the second half of each selection period. In contrast, the gate pulse signal may be changed in response to the polarity inversion of the source voltage.

FIG. 7(C) shows such a case. In the case shown in FIG. 7(C), the gate pulse signal has a low level (hereinafter called “L”) at the first half of each selection period and is “H” at the second half. In this case, the TFTs 116 connected to each gate line are turned on only in the second half of each selection period, and the pixel electrodes receive the source voltages only in the second half of each selection period.

A gate pulse signal shown in FIG. 7(D) may be used. In the case shown in FIG. 7(D), the gate pulse signal is “H” at the first half of each selection period and is “L” at the second half. In this case, the TFTs 116 connected to each gate line are turned on only in the first half of each selection period, and the pixel electrodes receive the source voltages only in the first half of each selection period.

In the predetermined frame, the case shown in FIG. 7(A) and FIG. 7(C) is used, and the positive-polarity source voltage is applied to the pixel electrodes as a driving voltage in the second half of each selection period. In the next frame of the predetermined frame, the case shown in FIG. 7(A) and FIG. 7(D) is used, and the negative-polarity source voltage is applied to the pixel electrodes as a driving voltage in the first half of each selection period.

Therefore, the liquid crystal is driven by the positive-polarity voltage in the predetermined frame, and driven by the negative-polarity voltage in the next frame of the predetermined frame. In other words, the same driving voltage as in frame inversion driving is applied to the liquid crystal, all pixels are driven by the same-polarity voltage in a frame, and a horizontal electric field is not generated between vertically adjacent pixels.

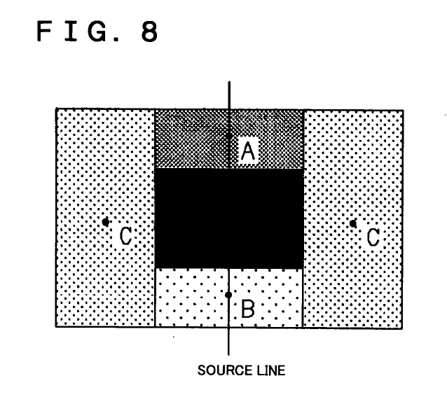

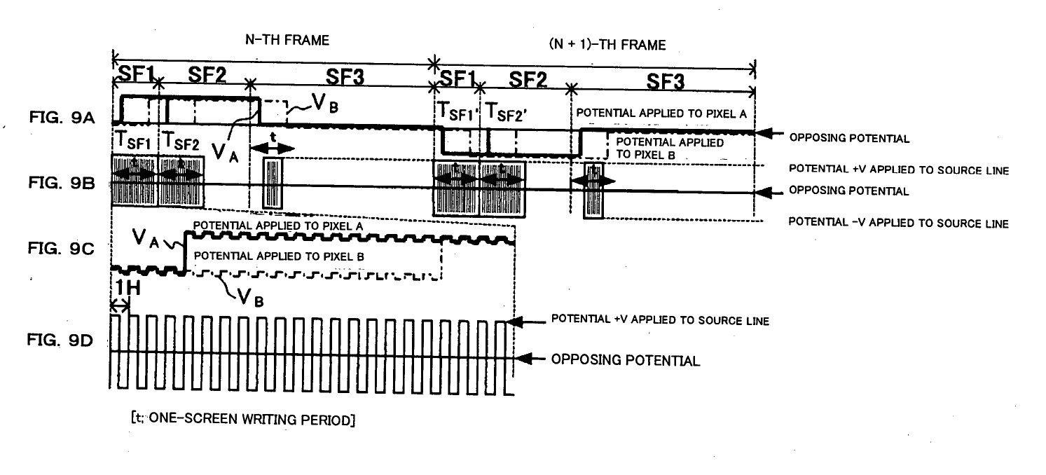

A reduction in vertical crosstalk according to the present exemplary embodiment will be described next by referring to FIG. 8 and FIG. 9. FIG. 8 shows an image in which a rectangular black part is located at the center of the screen and an intermediate-gradation gray part is located at the other area of the screen. FIG. 9 is a waveform view used to describe liquid-crystal driving voltages in the present exemplary embodiment. The number of pulses in a source line signal is the same as the number of gate lines, but for the simplicity of the figure, the number of pulses in one frame is made smaller than in an actual case in FIG. 9.

FIG. 9(B) shows a voltage applied to the source line. In FIG. 9(A), VA (thick line) and VB (one-dot chain line) indicate the voltages applied to the pixel electrodes at points A and B shown in FIG. 8, respectively. FIG. 9 shows driving voltage waveforms used when capacitor coupling occurs. FIG. 9(C) and FIG. 9(D) are time-expanded views of waveforms in the sub field SF1, shown in FIG. 9(A) and FIG. 9(B), respectively.

As shown in FIG. 9(D), the waveform of a source voltage applied to a source line located at the horizontal center of the image, such as that located at a vertical line passing through the points A and B shown in FIG. 8, is inverted in polarity at each (½)H period. When the N-th frame shown in FIG. 9 corresponds, for example, to the case shown in FIG. 7(D), the liquid crystal is driven by a positive-polarity voltage. In the (N+1)-th frame, the liquid crystal is driven by a negative-polarity voltage. The source potential has a large difference from the potential (opposing potential) of the opposing electrode at a position corresponding to the black part shown in FIG. 8, and has a small difference from the opposing potential at a position corresponding to the intermediate-gradation gray part, including points C.

FIG. 9(A) shows the voltages applied to the pixels at the points A and B shown in FIG. 8. In the selection period of each sub field, corresponding to the vertical screen position of the point A in the N-th frame, the TFT of the pixel at the point A is turned on, and a pulse signal (driving voltage) which changes between the on voltage and the off-voltage according to the intermediate-gradation gray part is applied to the pixel electrode at the point A. In the case shown in FIG. 9, the fourth gradation (gradation 3) is displayed among gradations 0 to 7 as gray. In the selection period TSF1 corresponding to the point A in the sub field SF1, the pulse signal having the on-voltage is applied to the pixel electrode at the point A.

In the selection period in which data to be displayed is sent to a pixel at the line next to the point A, the TFT of the pixel at the point A is turned off, the driving voltage of the pixel electrode at the point A is maintained by the liquid-crystal capacitor and the storage capacitor until the corresponding selection period TSF2 in the next sub field. Also in the next selection period TSF2, the pulse signal having the on-voltage is applied to the pixel electrode at the point A. This on-voltage is maintained until the corresponding selection period in the sub field SF3. In the corresponding selection period in the sub field SF3, the pulse signal having the off-voltage is applied to the pixel electrode at the point A.

The same applies to the pixel electrodes at the other points. The on-voltage or the off-voltage is applied according to the data signal in the corresponding selection period in each sub field, and it is maintained until the corresponding selection field in the next sub field.

In the selection period of each sub field, corresponding to the vertical screen position of the point A in the (N+1)-th frame, a negative-polarity driving voltage is applied to the pixel at the point A. In other words, the negative-polarity driving voltage is applied in the corresponding selection period TFS1′ in the first sub field SF1, and the driving voltage is maintained until the corresponding selection period TSF2′ in the next sub field. The same applies to the point B, and a driving voltage applied to the pixel electrode of the pixel at the point B in each sub field is maintained until the corresponding selection period in the next sub field. In this way, the intermediate-gradation gray part includes not only the points C of FIG. 8 but also the points A and B.

In the present exemplary embodiment, as described above, a source voltage which is inverted in polarity at each (½)H period is sent to the pixel electrode of each pixel.

When capacitor coupling occurs, each pixel electrode is affected by the source-line voltage. FIG. 9(C) shows such a situation. The level of each pixel electrode fluctuates according to the level of the source voltage changed. This fluctuation occurs at each (½)H period, which is short. The voltage applied to the pixel electrode is inverted at each (½)H period, which is relatively short, both in the intermediate-gradation display period and the black-part display period. Therefore, the fluctuation of the voltage applied to each source line has a relatively small amplitude.

Consequently, the fluctuation of the on-voltage and that of the off-voltage are sufficiently small, and the luminance obtained in the intermediate-gradation display period is almost the same as the intermediate-gradation luminance obtained when the ideal voltage is applied to each pixel.

Also in the black part, the positive-polarity voltage and the negative-polarity voltage are applied to each pixel electrode in a 1H period. Also in this case, the voltages applied to the pixel fluctuate just at relatively small amplitudes. The effective values of the voltages applied to the liquid crystal are almost the same as the effective values of the applied voltages obtained when there is no effect of the source lines.

In this way, a driving voltage almost the same as the driving voltage applied to the pixels at the points C is applied to the liquid crystal, and almost uniform brightness is obtained at the screen area where the intermediate-gradation gray part is displayed.

Whereas the level of the source potential fluctuates according to an image in the voltage modulation method, the source voltage is binary in the pulse-width modulation method. Therefore, in the pulse-width modulation method, current leakage from transistors is a more dominant factor for vertical crosstalk than capacitor coupling generated between the source electrodes and the pixel electrodes.

As described above, in the present exemplary embodiment, polarity inversion driving at each frame is applied to the liquid crystal, and polarity inversion driving at each (½)H period is also applied to the liquid crystal. Therefore, the effect of horizontal electric field is avoided, and vertical crosstalk is suppressed.

It is obvious that the present invention can also be applied in the same manner to sub-field driving which uses unweighted sub fields having an equal width.

In the above-described exemplary embodiment, polarity inversion driving at each (½)H period is achieved, and polarity inversion driving at each frame is also performed. In an aspect of the present invention, polarity inversion driving with a positive-polarity voltage and a negative-polarity voltage needs to be applied to liquid crystal in a selection period. Polarity inversion driving at each half of each selection period is not necessarily applied to liquid crystal. For example, depending on the driving capacity of the X driver, the period in which a voltage is finally applied to each pixel electrode can be set shorter than half the selection period. Conversely, it can be set longer than half the selection period.

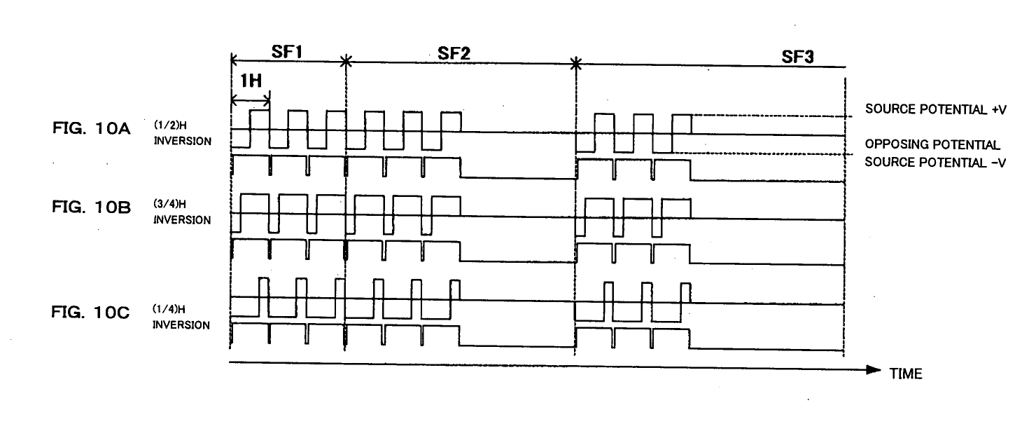

FIG. 10 is a waveform view for such cases. FIG. 10 is a waveform view showing the relationships between gate pulse signals and source potentials, and shows the source potentials at upper sides and the gate pulse signals at lower sides in the same way as in FIG. 7. FIG. 10(A) shows the same (½)H inversion driving as in the above-described embodiment, FIG. 10(B) shows (¾)H inversion driving, and FIG. 10(C) shows (¼)H inversion driving. For the simplicity of the figure, in FIG. 10, the number of pulses in one frame is set smaller than in an actual case.

FIG. 10(A) shows the same source voltage and the same gate pulse signal as in FIG. 7(A) and FIG. 7(B). FIG. 10(B) shows a case in which the voltage raising circuit 540 inverts the polarity of the source voltage at a (¼)H period from the start of a 1H period whereas the same gate pulse signal as that shown in FIG. 7(B) is used. The source voltage has the negative polarity at the (¼)H period and has the positive polarity at the remaining (¾) period. A voltage applied to each pixel is finally determined by the voltage obtained at the (¾)H period. Therefore, in this case, even if the driving capacity of the X driver is low, writing is applied to the liquid crystal with no problem.

FIG. 10(C) shows a case in which the polarity inversion circuit 302 inverts the polarity of the source voltage at a (¾)H period from the start of a 1 H period whereas the same gate pulse signal as that shown in FIG. 7(B) is used. The source voltage has the negative polarity at the (¾)H period and has the positive polarity at the remaining (¼) period. A voltage applied to each pixel is finally determined by the voltage obtained at the (¼)H period.

The source voltage needs to be inverted in polarity in a 1H period in this way. The polarity inversion period is not limited to the (½)H period. It may be the period obtained by diving a 1H period at any division ratio.

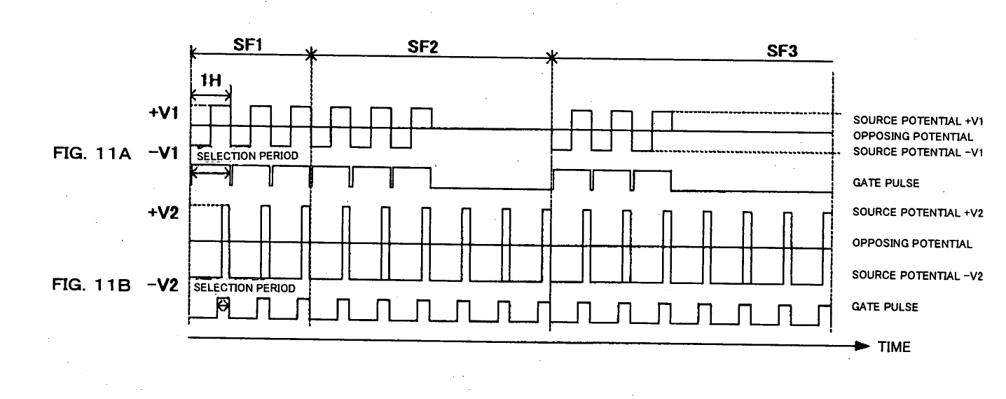

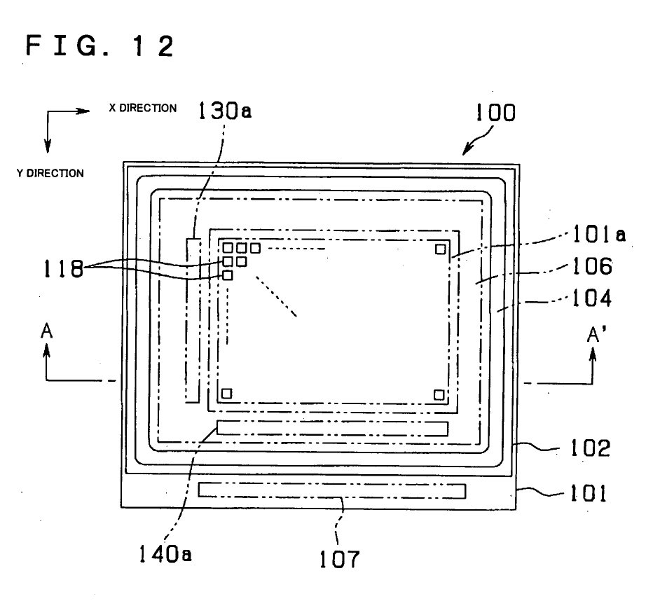

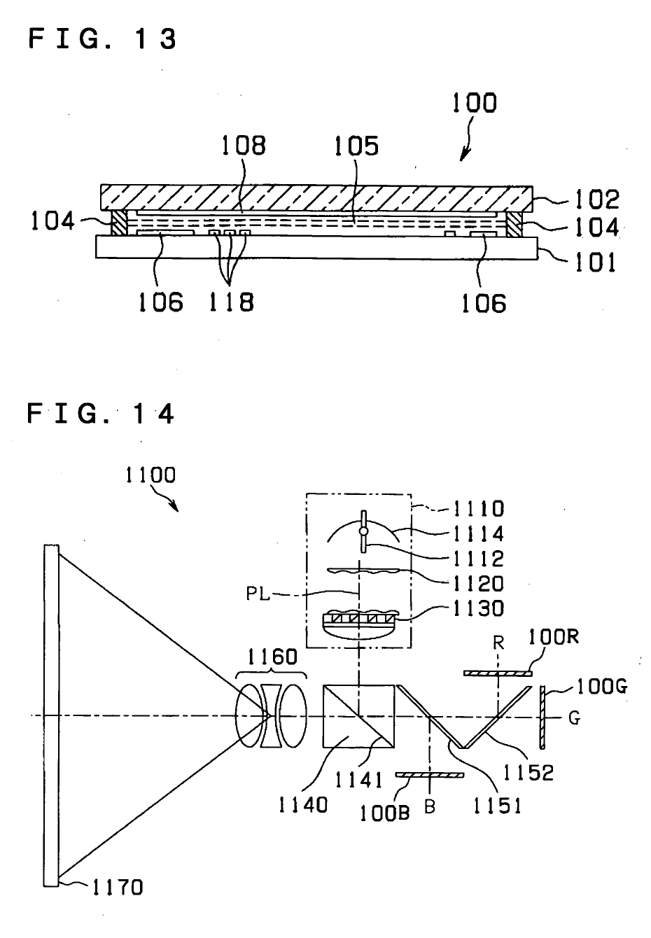

When voltages applied to source lines are not symmetrical, as in the cases shown in FIG. 10(B) and FIG. 10(C), the voltage fluctuation shown in FIGS. 9(A)-9(D) also becomes asymmetrical, and effective voltages applied to liquid crystal are changed from the ideal values. To make the effective voltages applied to the liquid crystal close to the ideal values, the voltages applied to the source lines may be changed. FIG. 11 shows such a case.

FIG. 11 is a waveform view showing the relationships between gate pulse signals and source potentials, and shows the source potentials at upper sides and the gate pulse signals at lower sides in the same way as in FIG. 7. FIG. 11(A) shows the same (½)H polarity inversion driving as in the above-described embodiment, FIG. 11(B) shows (¼)H inversion driving corresponding to FIG. 7(C) and FIG. 10(C). For the simplicity of the figure, in FIG. 11, the number of pulses in one frame is set smaller than in an actual case.

FIG. 11(A) shows the same source voltage and the same gate pulse signal as in FIG. 7(A) and FIG. 7(B). FIG. 11(B) shows the gate pulse signal corresponding to FIG. 7(C) and FIG. 10(C). In the case shown in FIG. 11(B), (¼)H inversion driving is employed, and a TFT 116 is turned on at the (¼)H period located at the end of a 1H period and a gate pulse is generated at the (¼)H period to send the source voltage from the TFT 116 to the pixel electrode. In addition, the source voltage range is set to the range from −V2 to +V2 which is larger than the source voltage range (−V1 to +V1) used in (½)H inversion driving.

Depending on the response of liquid crystal, when a writing period for pixel electrodes is short, the voltage of the liquid crystal does not increase to a desired writing voltage corresponding to data to be displayed, in some cases. Even in such a case, if the source voltage range is increased according to the level of the data to be displayed and the writing period for the pixel electrodes, as in the case shown in FIG. 11(B), it becomes possible to drive the liquid crystal at the desired writing voltage corresponding to the data to be displayed.

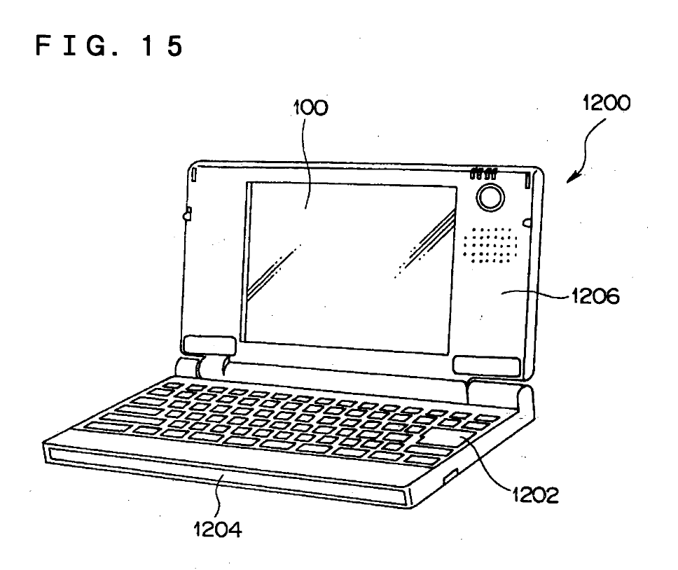

The structure of the liquid-crystal apparatus according to the above-described exemplary embodiment or other application aspects will be described next by referring to FIG. 12 and FIG. 13. FIG. 12 is a plan showing the structure of the liquid-crystal apparatus 100. FIG. 13 is a cross-sectional view taken on plane A-A′ shown in FIG. 12.

As shown in these figures, in the liquid-crystal apparatus 100, the element substrate 101 on which the pixel electrodes 118 are formed and the opposing substrate 102 on which the opposing electrode 108 is formed are attached to each other by a sealing member 104 with a constant gap therebetween, and the liquid crystal 105, which is an electro-optic material, is sandwiched by the substrates in the gap. Actually, the sealing member 104 has an opening, the liquid crystal 105 is put in through the opening, and then, the opening is sealed by a sealant. The opening is not shown in the figures.

The opposing substrate 102 is a transparent substrate made from glass or others. In the above description, the element substrate 101 is formed of a transparent substrate. In a reflective liquid-crystal apparatus, the element substrate may be formed of a semiconductor substrate. In this case, since the semiconductor substrate is opaque, the pixel electrodes 118 are made from a reflective metal, such as aluminum.

On the element substrate 101, a light-shielding film 106 is formed inside the sealing member 104 and outside the display area 101a. In the area where the light-shielding film 106 is formed, the Y driver 401 is formed at an area 130a and the X driver 500 is formed at an area 140a.

The light-shielding film 106 reduces or prevents light from being incident on the driving circuits formed in the area. The opposing-electrode voltage VLCCOM is applied to the light-shielding film 106 and to the opposing electrode 108.

On the element substrate 101, a plurality of connection terminals are formed in an area 107 which is outside the area 140a, where the X driver 500 is formed, and also outside the sealing member 104, and control signals, power lines, and others are externally connected thereto.

The opposing electrode 108 provided for the opposing substrate 102 is electrically connected to the light-shielding film 106 and a connection terminal provided for the element substrate by an electrically conductive member (not shown) provided at at least one of the four corners of a substrate attaching part. More specifically, the opposing-electrode voltage VLCCOM is applied to the light-shielding film 106 through the connection terminal provided for the element substrate 101, and further applied to the opposing electrode 108 through the electrically conductive member.

According to the use of the liquid-crystal apparatus 100, in a direct-see type, the opposing substrate 102 is provided first with a color filter arranged in a stripe manner, in a mosaic manner, or in a triangle manner, and secondly with a light-shielding film (black matrix) made, for example, from a metallic material or a resin. When the liquid-crystal apparatus 100 is used for color-light modulation, for example, if it is used as a light valve of a projector, described later, a color filter is not formed. In a direct-see type, a light source to emit light through the opposing substrate 102 or through the element substrate to the liquid-crystal apparatus 100 is provided, if necessary. In addition, between the electrodes of the element substrate 101 and the opposing substrate 102, alignment layers (not shown) to which a rubbing process has been applied in determined directions are provided to specify the alignment direction of liquid-crystal molecules in a state where no voltage is applied. A polarizer (not shown) based on the alignment direction is also provided at the side of the opposing substrate 102. When polymer dispersed liquid crystal, in which minute liquid-crystal particles are dispersed in polymer, is used as the liquid crystal 105, the alignment layers or the polarizer, described above, is not required. As a result, light-use efficiency is increased, and it is advantageous in terms of higher luminance and lower power consumption.

Example electronic units which use the above-described liquid-crystal apparatus will be described next.

A projector which uses the liquid-crystal apparatus according to the above-described exemplary embodiment as a light valve will be described first. FIG. 14 is a plan showing the structure of the projector. As shown in the figure, a polarized-light illumination apparatus 1110 is arranged along a system optical axis PL in the projector 1100. In the polarized-light illumination apparatus 1110, light emitted from a lamp 1112 is reflected by a reflector 1114 to generate almost-parallel luminous flux, and incident on a first integrator lens 1120. With this, the light emitted from the lamp 1112 is divided into a plurality of intermediate luminous flux. The plurality of intermediate luminous flux are converted to one type of polarized luminous flux (s-polarized luminous flux) having almost the same polarization direction by a polarization conversion element 1130 having a second integrator lens at the light input side, and output from the polarized-light illumination apparatus 1110.

The s-polarized luminous flux output from the polarized-light illumination apparatus 1110 is reflected by the s-polarized-luminous-flux reflection plane 1141 of a polarized-light beam splitter 1140. In the reflected luminous flux, blue-light (B) luminous flux is reflected by the blue-light reflection layer of a dichroic mirror 1151, and modulated by a reflective liquid-crystal apparatus 10B. In luminous flux which passes through the blue-light reflection layer of the dichroic mirror 1151, red-light (R) luminous flux is reflected by the red-light reflection layer of a dichroic mirror 1152, and modulated by a reflective liquid-crystal apparatus 100R.

In the luminous flux which passes through the blue-light reflection layer of the dichroic mirror 1151, green-light (G) luminous flux passes through the red-light reflection layer of the dichroic mirror 1152, and modulated by a reflective liquid-crystal apparatus 100G

The red light, green light, and blue light color-modulated by the liquid-crystal apparatuses 100R, 100G and 100B in this way are sequentially combined by the dichroic mirrors 1152 and 1151 and the polarized-light beam splitter 1140, and then, projected to a screen 1170 by a projection optical system 1160. Since the R, G and B primary-color luminous flux is incident on the liquid-crystal apparatuses 100R, 100G and 100B, respectively, by the dichroic mirrors 1151 and 1152, a color filter is not necessary for the liquid-crystal apparatuses.

In the present exemplary embodiment, the reflective liquid-crystal apparatuses are used. A projector which uses a transmissive liquid-crystal apparatus may be used.

A case in which the above-described liquid-crystal apparatus is applied to a mobile personal computer will be described next. FIG. 15 is a perspective view showing the structure of the personal computer. In the figure, the computer 1200 is formed of a body 1204 having a keyboard 1202, and a display unit 1206. The display unit 1206 is formed of the liquid-crystal apparatus 100, described before, with a front light being added at the front surface of the liquid-crystal apparatus 100.

Since the liquid-crystal apparatus 100 is used as a reflection direct-see type apparatus in this structure, it is preferred that the pixel electrodes 118 have uneven surfaces so as to disperse reflected light in various directions.

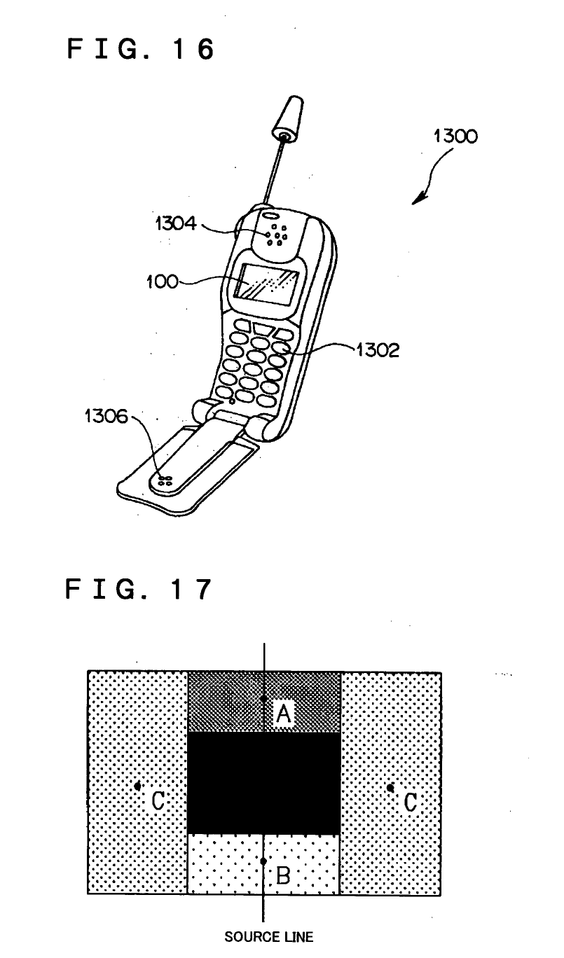

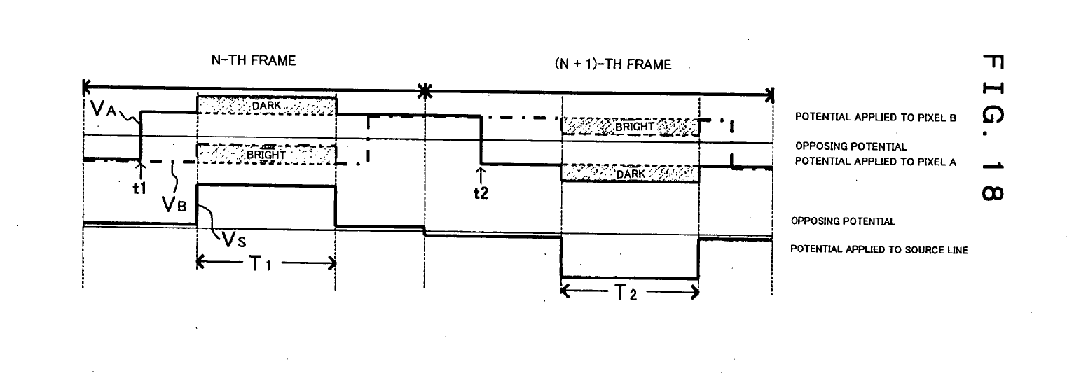

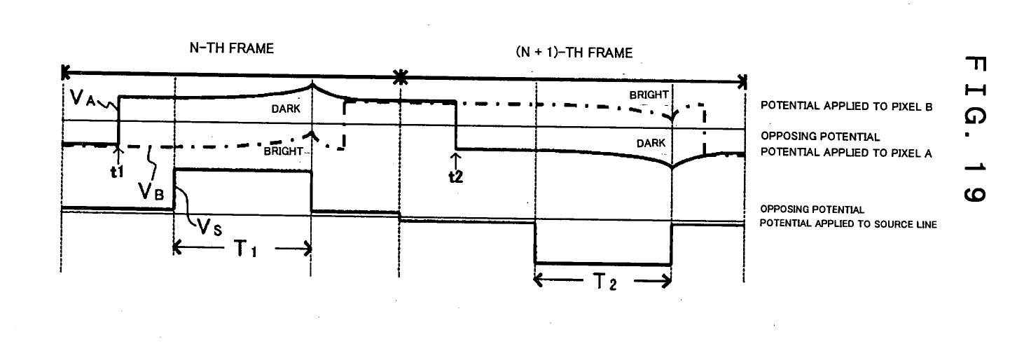

A case in which the above-described crystal apparatus is applied to a portable telephone will be described next. FIG. 16 is a perspective view showing the structure of the portable telephone. In the figure, the portable telephone 1300 includes a plurality of operation buttons 1302, a receiver 1304, a transmitter 1306, and the liquid-crystal apparatus 100.

If necessary, a front light is provided for the liquid-crystal apparatus 100 at its front surface. Since the liquid-crystal apparatus 100 is also used as a reflection direct-see type apparatus in this structure, it is preferred that the pixel electrodes 118 have uneven surfaces.

As electronic units, in addition to those described by referring to FIG. 15 and FIG. 16, there are liquid-crystal TV sets, view-finder-type and monitor-direct-see-type video cassette-tape recorders, car navigation apparatuses, pagers, electronic notebooks, electronic calculators, word processors, workstations, TV phones, POS terminals, units having touch-sensitive panels, and others. It is obvious that the liquid-crystal apparatuses according to the above-described exemplary embodiments can be applied to these various electronic units.

In the above exemplary embodiment, the case in which 1H-period inversion driving and frame inversion driving are combined has been described. The present invention can also be applied to a combination of 1H inversion driving, and 1H inversion, source inversion, or dot inversion driving.

What is claimed is:

1. A liquid-crystal apparatus, comprising:
a liquid-crystal display section in which pixels are formed correspondingly to intersections of a plurality of source lines and a plurality of gate lines arranged in a grid manner, and switching elements provided for the pixels are turned on by gate signals sent to the gate lines to allow source voltages sent to the source lines to be given to the pixel electrodes of the pixels through the switching elements to drive liquid crystal;
a Y driver to sequentially send the gate signals to the gate lines in the liquid-crystal display section;
data-signal generation device to divide a field into a plurality of sub fields in the time axis, to use a sub field as a control unit, and to generate a data signal which is used for sub-field driving where a gradation expression is achieved according to a state and a time ratio of a light transmission state and a light non-transmission state of the liquid crystal in a unit time by sending an on-voltage which can saturate the transmittance of the liquid crystal or an off-voltage which can make the liquid crystal have the light non-transmission state, and which specifies a sub field to which the on-voltage is applied and a sub field to which the off-voltage is applied, according to data to be displayed; and
X driver device to generate the on-voltage or the off-voltage according to the data signal, to invert the generated on-voltage or off-voltage in polarity in a selection period in which pixels arranged on one line in the gate-line direction are driven in the liquid-crystal display section, and to send the generated on-voltage or off-voltage to the source lines as the source voltages.

2. The liquid-crystal apparatus according to claim 1, the Y driver generating gate signals used to send the source voltages to the pixel electrodes at least in one of the periods before and after the switching timing when the on-voltage or the off-voltage inverted in polarity by the X driver device is changed from one polarity to the other polarity or from the other polarity to the one polarity.

3. The liquid-crystal apparatus according to claim 1, the X driver device setting the switching timing when the on-voltage or the off-voltage is changed from one polarity to the other polarity or from the other polarity to the one polarity, at an interval of a half of the selection period in which pixels arranged on one line in the gate-line direction are driven in the liquid-crystal display section.

4. The liquid-crystal apparatus according to claim 1, the X driver device setting the switching timing when the on-voltage or the off-voltage is changed from one polarity to the other polarity or from the other polarity to the one polarity, at an interval other than that of a half of the selection period in which pixels arranged on one line in the gate-line direction are driven in the liquid-crystal display section.

5. The liquid-crystal apparatus according to claim 1, the Y driver generating gate signals used to send the source voltages to the pixel electrodes at least in one of the periods before and after the switching timing when the on-voltage or the off-voltage inverted in polarity by the X driver device is changed from one polarity to the other polarity or from the other polarity to the one polarity; and
the X driver device changing the polarity of the n-voltage or the off-voltage according to the ratio of the selection period in which pixels arranged on one line in the gate-line direction are driven in the liquid-crystal display section and a period in which the gate signals used to send the source voltages to the pixel electrodes are being generated.

6. The liquid-crystal apparatus according to claim 1, the X driver device inverting the polarity of the generated on-voltage or off-voltage at each period in which pixels arranged in all lines in the liquid-crystal display section are driven, and sending the on-voltage or off-voltage to the source lines as the source voltages.

7. A driving method for a liquid-crystal apparatus including a liquid-crystal display section in which pixels are formed correspondingly to the intersections of a plurality of source lines and a plurality of gate lines arranged in a grid manner, and switching elements provided for the pixels are turned on by gate signals sent to the gate lines to allow source voltages sent to the source lines to be given to the pixel electrodes of the pixels through the switching elements to drive liquid crystal, the driving method comprising:
sequentially sending the gate signals to the gate lines in the liquid-crystal display section;
dividing a field into a plurality of sub fields in the time axis, using a sub field as a control unit, and generating a data signal which is used for sub-field driving where a gradation expression is achieved according to a state and a time ratio of a light transmission state and a light non-transmission state of the liquid crystal in a unit time by sending an on-voltage which can saturate the transmittance of the liquid crystal or an off-voltage which can make the liquid crystal have the light non-transmission state, and which specifies a sub field to which the on-voltage is applied and a sub field to which the off-voltage is applied, according to data to be displayed; and
generating the on-voltage or the off-voltage according to the data signal, inverting the generated on-voltage or off-voltage in polarity in a selection period in which pixels arranged on one line in the gate-line direction are driven in the liquid-crystal display section, and sending the generated on-voltage or off-voltage to the source lines as the source voltages.

8. The driving method for a liquid-crystal apparatus, according to claim 7, sending the source voltages to the source lines, comprising:
inverting the polarity of the generated on-voltage or off-voltage at each period in which pixels arranged in all lines in the liquid-crystal display section are driven.

9. An electronic unit, comprising:
a liquid-crystal apparatus according to claim 1.
